(19) United States
(12) Patent Application Publication
(10) Pub. No.: US 2025/0356840 A1
(43) Pub. Date: Nov. 20, 2025

(54) METHOD, APPARATUS, DEVICE, AND STORAGE MEDIUM FOR SPEECH SYNTHESIS

(71) Applicants: Beijing Zitiao Network Technology Co., Ltd., Beijing (CN); Lemon Inc., Grand Cayman (KY)

(72) Inventors: Yuanhao Yi, Beijing (CN); Jian Wu, Los Angeles, CA (US); Junteng Zhang, Beijing (CN); Wenjie Zhang, Beijing (CN); Xingxing Li, Beijing (CN); Zhuo Chen, Los Angeles, CA (US); Yuanyuan Huo, Beijing (CN); Yuping Wang, Beijing (CN)

(21) Appl. No.: 19/207,271

(22) Filed: May 13, 2025

(30) Foreign Application Priority Data
May 14, 2024 (CN) 202410598591.0

(51) Int. Cl. G10L 13/047; G10L 13/08

(52) U.S. Cl. CPC G10L 13/047; G10L 13/08

(57) ABSTRACT

A method, an apparatus, a device, and a storage medium for speech synthesis are provided. A reference description feature corresponding to prompted speech content is obtained, the reference description feature includes a text encoding representation determined by processing the prompted speech content with a contrastive learning module, and the text encoding representation describes a first expression state of the prompted speech content. Based on the reference description feature, a target description feature for indicating a target expression state is constructed. Target speech content corresponding to the target expression state is generated based on an input phoneme sequence including the target description feature.

### CROSS REFERENCE

This application claims priority to Chinese Application No. 202410598591.0, filed on May 14, 2024, and entitled “METHOD, APPARATUS, DEVICE, AND STORAGE MEDIUM FOR SPEECH SYNTHESIS”, the entirety of which is incorporated herein by reference.

### FIELD

Example embodiments of the disclosure generally relate to the field of computers, and in particular, to a method, an apparatus, a device, and a computer-readable storage medium for speech synthesis.

### BACKGROUND

In recent years, with the rapid development of computer technologies, more and more applications and platforms are currently designed to provide various services to users. For example, applications/platforms are designed to provide speech synthesis (TTS) services to users. The application/platform may, for example, implement text-to-speech by means of a speech synthesis system (for example, a speech synthesis model) to generate audio corresponding to the text.

### SUMMARY

In a first aspect of the disclosure, a method of speech synthesis is provided. The method includes: obtaining a reference description feature corresponding to prompted speech content, the reference description feature including a text encoding representation determined by processing the speech content with a contrastive learning module, and the text encoding representation describing a first expression state of the prompted speech content; constructing, based on the reference description feature, a target description feature for indicating a target expression state; and generating target speech content corresponding to the target expression state based on an input phoneme sequence including the target description feature.

In a second aspect of the disclosure, an apparatus for speech synthesis is provided. The apparatus includes: an obtaining module configured to obtain a reference description feature corresponding to prompted speech content, the reference description feature including a text encoding representation determined by processing the speech content with a contrastive learning module, and the text encoding representation describing a first expression state of the prompted speech content; a construction module configured to construct, based on the reference description feature, a target description feature for indicating a target expression state; and a generation module configured to generate target speech content corresponding to the target expression state based on an input phoneme sequence including the target description feature.

In a third aspect of the disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the disclosure, a computer-readable storage medium is provided. The computer-readable storage medium has a computer program stored thereon, and the computer program is executable by a processor to implement the method of the first aspect.

It should be understood that the content described in this content section is not intended to limit the key features or major features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the disclosure may be implemented;

FIGS. 2A-2D illustrate example frameworks for model training according to some embodiments of the disclosure;

FIG. 3 illustrates a flowchart of an example process of speech synthesis according to some embodiments of the disclosure;

FIG. 4 illustrates a schematic structural block diagram of an example apparatus for speech synthesis according to some embodiments of the disclosure; and

FIG. 5 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as being limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the disclosure, the terms “including” and the like should be understood to mean open-ended inclusion, i.e., “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of a user, acquisition and/or use of data, and the like. These aspects all follow the corresponding laws and regulations and related regulations. In the embodiments of the disclosure, all data collection, acquisition, treatment, processing, forwarding, use and the like are performed on the premise that the user knows and confirms. Accordingly, when implementing the embodiments of the disclosure, the type, the usage scope, the usage scenario, and the like of the data or information that may be involved should be notified to the user and obtain the authorization from the user in an appropriate manner according to the relevant laws and regulations. The specific notification and/or authorization manner may vary according to actual situations and application scenarios, and the scope of the disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing may be performed only within a specified or agreed range. In the case that the user refuses personal information other than necessary information required by the basic function, the use of the basic function will not be affected.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. A neural network model is one example of a deep learning-based model. As used herein, the “model” may also be referred to as a “machine learning model,” a “learning model,” a “machine learning network,” or a “learning network,” which terms are used interchangeably herein.

The “neural network” is a deep learning-based machine learning network. The neural network is capable of processing inputs and providing respective outputs, which generally include an input layer and an output layer and one or more hiding layers between the input layer and the output layer. The neural network used in a deep learning application generally includes many hiding layers, increasing the depth of the network. Respective layers of the neural network are connected in sequence such that an output of the previous layer is provided as an input to the next layer, where the input layer receives the input of the neural network and the output of the output layer serves as a final output of the neural network. Each layer of the neural network includes one or more nodes (also referred to as processing nodes or neurons), each node processing the input from the previous layer.

Generally, the machine learning may generally include three phases, i.e., a training phase, a testing phase, and an application phase (also referred to as an inference phase). At the training phase, a given model may be trained by using a large amount of training data, constantly updating parameter values, until the model is able to obtain consistent inferences from the training data that satisfy the expected objectives. By training, the model may be considered to be able to learn from the training data an association from input to output (also referred to as mapping of input to output). The parameter values of the trained model are determined. In the testing phase, the test input is applied to the trained model to test whether the model may provide the correct output, thereby determining the performance of the model. The testing phase may sometimes be fused in the training phase. In the application or inference phase, the trained model may be used to process the actual model input based on the parameter value obtained by training, to determine a corresponding model output.

As mentioned above, in recent years, with the rapid development of computer technologies, more and more applications and platforms are designed to provide various services to users. For example, the application/platform is designed to provide a speech synthesis (TTS) service to the user. The application/platform may, for example, implement text-to-speech by means of a speech synthesis system (for example, a speech synthesis model) to generate audio corresponding to the text. However, the audio generated by the conventional speech synthesis system cannot describe an expression state of the audio or has a singular expression state, resulting in a poor presentation effect of the generated speech content.

An embodiment of the disclosure provides a speech synthesis solution. According to the solution, a reference description feature corresponding to prompted speech content is obtained, the reference description feature includes a text encoding representation determined by processing the speech content with a contrastive learning module, and the text encoding representation describing a first expression state of the prompted speech content; based on the reference description feature, a target description feature for indicating a target expression state is constructed; and based on an input phoneme sequence including the target description feature, target speech content corresponding to the target expression state is generated.

In this way, the embodiments of the disclosure may accurately control the expression state of the generated speech content based on the reference description feature of the prompted speech content.

Various example implementations of this solution are described in detail below in conjunction with the accompanying drawings.

### Example Environment

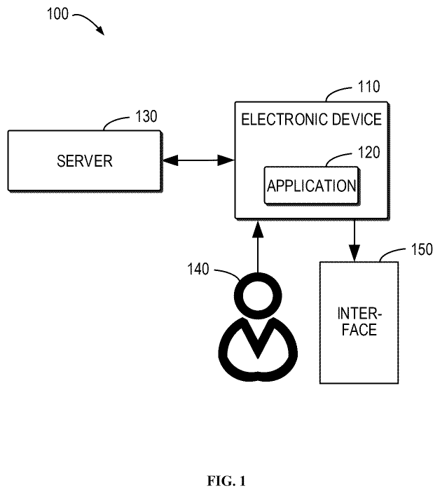

FIG. 1 illustrates a schematic diagram of an example environment 100 in which embodiments of the disclosure may be implemented. In the example environment 100, an application 120 is installed in the electronic device 110. A user 140 may interact with the application 120 via the electronic device 110 and/or its attachment device. The application 120 may be a speech synthesis application or the like, or any other suitable application with speech synthesis capability. Alternatively, the application 120 may also be a browser, and the user 120 may access a corresponding website through the browser to obtain a service related to speech synthesis.

In the environment 100 of FIG. 1, if the application 120 is an activated state, electronic device 110 may present an interface 150 of the application 120. The interface 150 may include various interfaces that the application 120 may provide, such as a text-based speech synthesis interface.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 that supports virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this regard. In the embodiment of the disclosure, the server 130 and the electronic device 110 may implement signaling interaction through the communication connection between the server 130 and the electronic device 110.

It should be understood that the structures and functions of various elements in the environment 100 are described for illustrative purposes only and do not imply any limitation to the scope of the disclosure.

Some example embodiments of the disclosure will be described below with continued reference to the accompanying drawings.

### Example Process

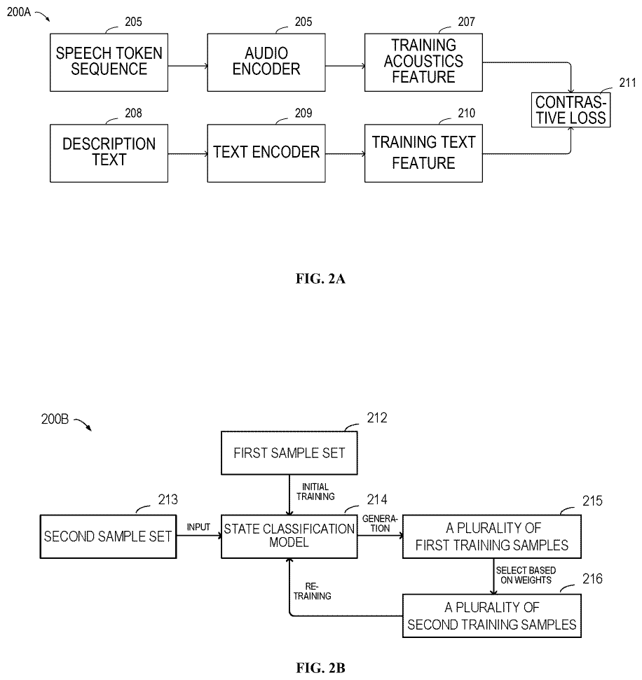

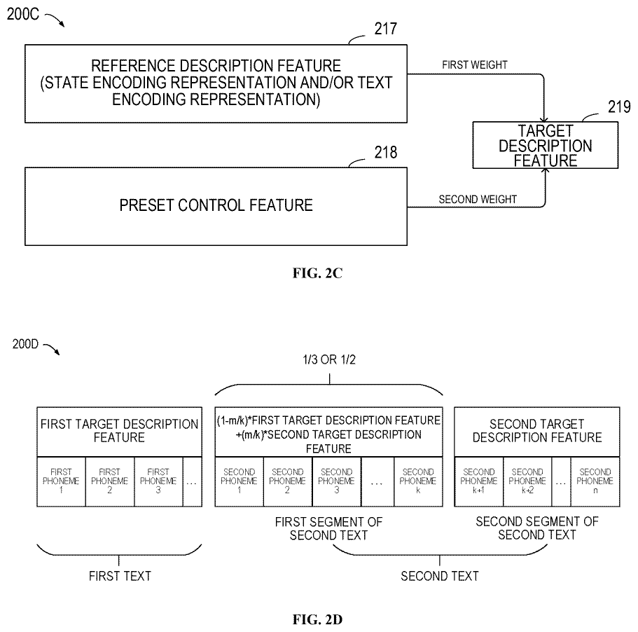

FIGS. 2A-2D illustrate example frameworks 200A through 200D of model training according to some embodiments of the disclosure; FIG. 3 illustrates a flowchart of an example process of speech synthesis according to some embodiments of the disclosure. The example frameworks 200A-200F and the process 300 may be implemented at the electronic device 110. The process 300 is described below with reference to FIGS. 1, 2A-2F.

As shown in FIG. 3, at block 310, the electronic device 110 may obtain a reference description feature corresponding to prompted speech content. The reference description feature may include a text encoding representation determined by processing the speech content with a contrastive learning module. The text encoding representation may be used to describe a first expression state of the prompted speech content.

In some embodiments, as shown in the example framework 200A shown in FIG. 2A, the contrastive training module may include an audio encoder 206 and a text encoder 209. In the training phase, the text encoder 209 processes a description text 208 to obtain a training text feature 210; in the inference phase, the text encoder 209 processes the training text feature 210 obtained by the description text 208 directly as the text encoding representation.

In some embodiments, with continued reference to FIG. 2A, the process of training the contrast learning module by the electronic device 110 may include generating a training acoustics feature 207 based on a speech token sequence 205 of a speech sample. As an example, the electronic device 110 may utilize the audio encoder 206 to process the speech token sequence 205 of the speech sample to generate the training acoustics feature 207.

In some embodiments, with continued reference to FIG. 2A, the process of training the contrastive learning module by the electronic device 110 may further include: generating the description text 208 for describing an expression state of the speech sample. Such an expression state may include a speaking state corresponding to the speech content.

In some embodiments, the electronic device 110 may process, using a language model, acoustics information and text information of the speech sample to generate the description text 208 for describing the expression state of the speech sample. As an example, the language model may be obtained by training through a supervised classification algorithm based on a training speech sample labeled with an expression state. Any model that may generate the description text for describing the expression state of the speech sample may be included in the language model of the disclosure, which is not limited in the disclosure.

In some embodiments, with continued reference to FIG. 2A, the electronic device 110 may process the description text 208 by using the text encoder 209 to generate the training text feature 210. As an example, the text encoder 209 may be any model for processing text content, for example, may be implemented as T5-small (Text-to-Text Transfer Transformer-small).

In some embodiments, the electronic device 110 may train the contrast learning module based on the training acoustics feature 207 and the training text feature 210 of the description text 208.

In some embodiments, with continued reference to the example framework 200A of FIG. 2A, the electronic device 110 may determine a contrastive loss 211 of the contrast training module based on the training acoustics feature 207 and the training text feature 210. Further, the electronic device 110 may adjust the model parameter of the contrastive training module based on the contrastive loss 211.

In some embodiments, the reference description feature further includes a state encoding representation of a second expression state. The second expression state is the first expression state or a preset expression state. As an example, the preset expression state may be set by a relevant person according to the needs of the speech synthesis scenario.

In some embodiments, the state encoding representation is determined based on a state classification model.

In some embodiments, as shown in the example framework 200B of FIG. 2B, the process of training the state classification model 214 by the electronic device 110 may include: training the state classification model 214 with a first sample set 212 having label information. As an example, the first sample set herein includes a plurality of speech samples, and the label information may describe an expression state of a corresponding speech sample.

In some embodiments, with continued reference to FIG. 2B, the process of training the state classification model 214 by the electronic device 110 may further include: processing a second sample set with the trained state classification model 214, the second sample set not having label information. As an example, the second sample set includes a plurality of speech samples without label information. As an example, a quantity of speech samples in the second sample set may be more than a quantity of speech samples in the first sample set.

In some embodiments, the electronic device 110 may process the second sample set with the trained state classification model 214 to obtain a plurality of first training samples 215. As an example, the plurality of first training samples 215 includes an expression state obtained by processing based on the state classification model 214, and an expression strength (a strength corresponding to the expression state) of the plurality of first training samples 215 exceeds a threshold.

In some embodiments, with continued reference to FIG. 2B, the process of training the state classification model 214 by the electronic device 110 may further include: further training the state classification model 214 with the plurality of first training samples 215.

In some embodiments, with continued reference to FIG. 2B, the process of training the state classification model 214 by the electronic device 110 may further include: setting weights based on a plurality of expression states, selecting a plurality of second training samples 216 from the plurality of first training samples 215 based on weights. Further, the electronic device 110 may further train the state classification model 214 with the plurality of second training samples 216. As an example, the electronic device 110 may further perform a training process similar to the foregoing second sample set with a third sample set or the like, to train the state classification model 214.

At block 320, the electronic device 110 may construct, based on the reference description feature, a target description feature for indicating a target expression state.

In some embodiments, the electronic device 110 may construct the target expression feature by fusing the reference description feature and a preset control feature. The preset control feature is an expression state independent feature (or a feature independent from an expression state) determined by a training process.

In some embodiments, as shown in the example framework 200C shown in FIG. 2C, the electronic device 110 may determine a first weight of the reference description feature 217 and a second weight of the preset control feature 218. Further, the electronic device 110 may further fuse the reference description feature 217 and the preset control feature 218 based on the first weight and the second weight to construct the target description feature 219.

In some embodiments, at least one of the first weight and the second weight is determined based on a configuration operation. That is, the specific values of the first weight and the second weight may be set by the relevant person as desired. Based on a difference between the first weight and the second weight value, a degree corresponding to the target expression state of the generated target speech content may be controlled.

At block 330, the electronic device 110 may generate target speech content corresponding to the target expression state based on an input phoneme sequence including the target description feature. As an example, the input phoneme sequence may include a plurality of phonemes, and the plurality of phonemes may respectively correspond to the same or different description features. As an example, the input phoneme sequence may be processed with a trained synthesis model to generate corresponding target speech content, so that the target speech content may correspond to the target expression state.

In some embodiments, the target expression state is a first target expression state, the target speech content is a first speech target speech content, the target description feature is a first target description feature, and the first target speech content corresponds to the first text.

In some embodiments, the electronic device 110 may further determine a second target description feature associated with the second text based on the foregoing method. Further, the electronic device 110 may update, based on the first target description feature, the second target description feature corresponding to a first segment of the second text to determine a third target description feature. The first segment is adjacent to the first text.

In some embodiments, the electronic device 110 may further generate second target speech content corresponding to the first segment based on the third target description feature. Further, the electronic device 110 may generate, based on the second target description feature, third target speech content corresponding to a second segment of the second text.

In some embodiments, as shown in the example framework shown in FIG. 2D, the electronic device 110 may determine weight information corresponding to a target phoneme in the first segment based on a distance from the target phoneme to the first text. As an example, as shown in FIG. 2D, if there are n second phonemes in the second text, the first segment of the second text may include k (for example, k=n/2 or k=n/3) second phonemes, a distance between a second phoneme 1 and the first text is 1/k, a distance between a second phoneme 2 and the first text is 2/k, and so on, and a distance between a second phoneme m (1≤m≤k) and the first text is m/k.

In some embodiments, the weight corresponding to the second target description feature is proportional to the distance, and the weight corresponding to the first target description feature is inversely proportional to the distance. As an example, for the second phoneme m (1≤m≤k), the weight corresponding to the second target description feature may be m/k, and the weight corresponding to the first target description feature may be (1−m/k).

In some embodiments, the electronic device 110 may determine, based on the weight information, a weighted sum of the first target description feature and the second description feature, as the third target description feature corresponding to the target phoneme. As an example, if the target phoneme is the second phoneme m (1≤m≤k), a formula for calculating the third target description feature corresponding to the target phoneme is: third target description feature=(1−m/k)*first target description feature+(m/k)*second target description feature.

In some embodiments, the input phoneme sequence includes an attribute description feature that indicates a target speech attribute. As an example, such a target speech attribute may include a timbre attribute. It should be understood that the usage or generation of such timbre information is performed with the knowledge and authorization of the corresponding speaker.

In some embodiments, the attribute description feature may include a first attribute description feature determined based on a specified attribute identifier. As an example, the electronic device 110 provides a preset attribute description library. The preset attribute description library may include a plurality of preset attribute description features, and the plurality of preset attribute description features respectively correspond to a plurality of attribute identifiers. Further, the electronic device 110 may determine the first attribute description feature from the preset attribute description library based on the specified attribute identifier. As an example, the preset attribute description library may be a preset timbre library, and the attribute description feature may correspond to a feature representation of a timbre. It should be understood that various timbres in the preset timbre library are used with the knowledge and authorization of the corresponding speaker.

In some embodiments, the attribute description feature may include a second attribute description feature generated by encoding an audio token sequence corresponding to the target speech attribute. As an example, the electronic device 110 generates the audio token sequence corresponding to the target speech attribute in response to receiving customized speech content. The target speech attribute corresponds to an attribute description feature associated with the customized speech content.

In some embodiments, the electronic device 110 may further generate the second attribute description feature based on encoding the audio token sequence and at least a part of the aforementioned reference description feature (e.g., the first expression state and/or the second expression state).

Based on the speech synthesis process described above, the embodiments of the disclosure can realize fine regulation of the expression state in the speech synthesis process, thereby improving the reality and expressive force of speech synthesis.

### Example Apparatus and Device

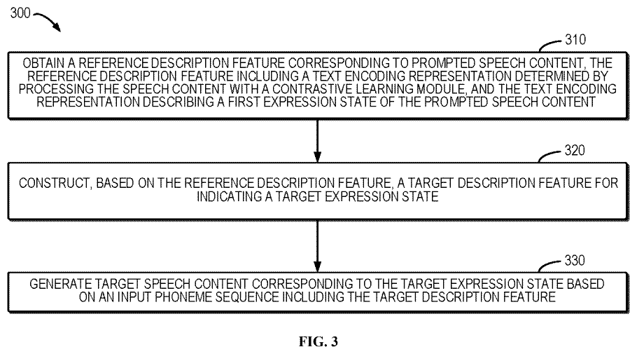

Embodiments of the disclosure also provide a corresponding apparatus for implementing the above method or process. FIG. 4 illustrates a schematic structural block diagram of an example apparatus 400 for speech synthesis according to some embodiments of the disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes an obtaining module 410 configured to obtain a reference description feature corresponding to prompted speech content, the reference description feature including a text encoding representation determined by processing the speech content with a contrastive learning module, and the text encoding representation describing a first expression state of the prompted speech content; a construction module 420 configured to construct, based on the reference description feature, a target description feature for indicating a target expression state; and a generation module 430 configured to generate target speech content corresponding to the target expression state based on an input phoneme sequence including the target description feature.

In some embodiments, the apparatus 400 further includes a training module, and the training module is further configured to train the contrastive learning module through: generating a training acoustics feature based on a speech token sequence of a speech sample; generating a description text for describing an expression state of the speech sample; and training the contrastive learning module based on the training acoustics feature and a training text feature of the description text.

In some embodiments, the training module is further configured to generate the description text for describing the expression state of the speech sample, i.e., including processing, using a language model, acoustics information and text information of the speech sample to generate the description text for describing the expression state of the speech sample.

In some embodiments, the obtaining module 410 is further configured such that the reference description feature further includes a state encoding representation of a second expression state, and the second expression state is the first expression state or a preset expression state.

In some embodiments, the obtaining module 410 is further configured such that the state encoding representation is determined based on a state classification model. The training module is further configured to: train the state classification model based on: training the state classification model with a first sample set having label information; processing a second sample set with the trained state classification model, the second sample set not having label information; determining, from the second sample set, a plurality of training samples with an expression strength exceeding a threshold; and further training the state classification model with the plurality of training samples.

In some embodiments, the constructing module 420 is further configured to construct, based on the reference description feature, the target description feature for indicating the target expression state, i.e., including constructing the target description feature by fusing the reference description feature and a preset control feature, the preset control feature being an expression state independent feature determined by a training process.

In some embodiments, the construction module 420 is further configured to construct the target description feature by fusing the reference description feature and the preset control feature, i.e., including: determining a first weight of the reference description feature and a second weight of the preset control feature; and fusing, based on the first weight and the second weight, the reference description feature and the preset control feature to construct the target description feature.

In some embodiments, the construction module 420 is further configured such that at least one of the first weight and the second weight is determined based on a configuration operation.

In some embodiments, the obtaining module 410 is further configured such that: the target expression state is a first target expression state, the target speech content is first target speech content, the target description feature is a first target description feature, the first target speech content corresponds to a first text, and the method further includes: determining a second target description feature associated with the second text; updating, based on the first target description feature, the second target description feature corresponding to a first segment of the second text to determine a third target description feature, the first segment being adjacent to the first text; generating, based on the third target description feature, second target speech content corresponding to the first segment; and generating, based on the second target description feature, third target speech content corresponding to a second segment of the second text.

In some embodiments, the obtaining module 410 is further configured to update: based on the first target description feature, the second target description feature corresponding to the first segment of the second text to determine the third target description feature, i.e., including: determining weight information corresponding to a target phoneme in the first segment based on a distance from the target phoneme to the first text; and determining, based on the weight information, a weighted sum of the first target description feature and the second target description feature as the third target description feature corresponding to the target phoneme.

In some embodiments, the obtaining module 410 is further configured such that a weight corresponding to the first target description feature is inversely proportional to the distance.

In some embodiments, the generation module 430 is further configured such that the input phoneme sequence further comprises an attribute description feature indicating a target speech attribute.

In some embodiments, the generation module 430 is further configured such that: the attribute description feature includes: a first attribute description feature determined based on a specified attribute identifier; or a second attribute description feature generated by encoding an audio token sequence corresponding to the target speech attribute.

In some embodiments, the generation module 430 is further configured such that: the second attribute description feature is generated by encoding at least a part of the reference description feature and the audio token sequence.

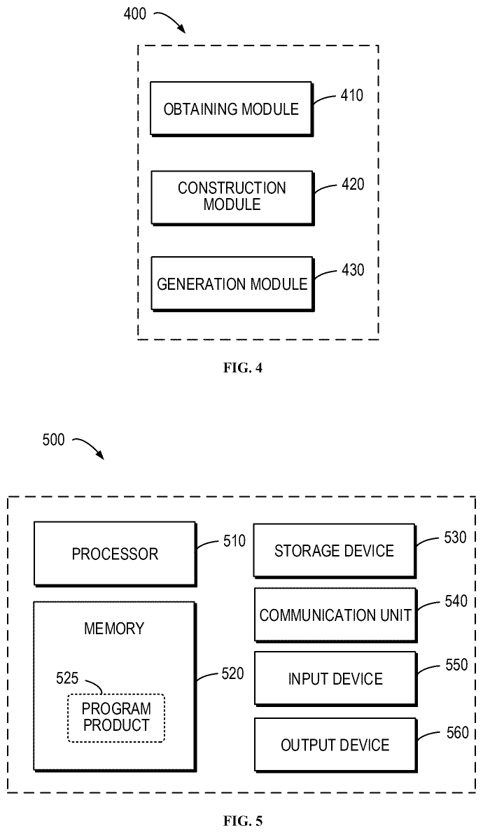

FIG. 5 illustrates a block diagram of an electronic device 500 in which one or more embodiments of the disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in a form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units executes computer-executable instructions in parallel to improve the parallel processing capability of the electronic device 500.

The electronic device 500 generally includes a plurality of computer storage media. Such media may be any available media that is accessible by the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network profile computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be executed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions/acts specified in one or more blocks in the flowchart(s) and/or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of speech synthesis, comprising:
obtaining a reference description feature corresponding to prompted speech content, the reference description feature comprising a text encoding representation determined by processing the prompted speech content with a contrastive learning module, and the text encoding representation describing a first expression state of the prompted speech content;
constructing, based on the reference description feature, a target description feature for indicating a target expression state; and
generating target speech content corresponding to the target expression state based on an input phoneme sequence comprising the target description feature.

2. The method of claim 1, further comprising training the contrastive learning module through:
generating a training acoustics feature based on a speech token sequence of a speech sample;
generating a description text for describing an expression state of the speech sample; and
training the contrastive learning module based on the training acoustics feature and a training text feature of the description text.

3. The method of claim 2, wherein generating the description text for describing the expression state of the speech sample comprises:
processing, using a language model, acoustics information and text information of the speech sample to generate the description text for describing the expression state of the speech sample.

4. The method of claim 1, wherein the reference description feature further comprises a state encoding representation of a second expression state, and the second expression state is the first expression state or a preset expression state.

5. The method of claim 4, wherein the state encoding representation is determined based on a state classification model, and the state classification model is trained through:
training the state classification model with a first sample set comprising label information;
processing a second sample set with the trained state classification model, the second sample set lacking label information;
determining, from the second sample set, a plurality of training samples with an expression strength exceeding a threshold; and
further training the state classification model with the plurality of training samples.

6. The method of claim 1, wherein constructing, based on the reference description feature, the target description feature for indicating the target expression state comprises:
constructing the target description feature by fusing the reference description feature and a preset control feature, the preset control feature being an expression state independent feature determined by a training process.

7. The method of claim 6, wherein constructing the target description feature by fusing the reference description feature and the preset control feature comprises:
determining a first weight of the reference description feature and a second weight of the preset control feature; and
fusing, based on the first weight and the second weight, the reference description feature and the preset control feature to construct the target description feature.

8. The method of claim 7, wherein at least one of the first weight or the second weight is determined based on a configuration operation.

9. The method of claim 1, wherein the target expression state is a first target expression state, the target speech content is first target speech content, the target description feature is a first target description feature, the first target speech content corresponds to a first text, and the method further comprises:
determining a second target description feature associated with a second text;
updating, based on the first target description feature, the second target description feature corresponding to a first segment of the second text, to determine a third target description feature, the first segment being adjacent to the first text;
generating, based on the third target description feature, second target speech content corresponding to the first segment; and
generating, based on the second target description feature, third target speech content corresponding to a second segment of the second text.

10. The method of claim 9, wherein updating, based on the first target description feature, the second target description feature corresponding to the first segment of the second text, to determine the third target description feature comprises:
determining weight information corresponding to a target phoneme in the first segment based on a distance from the target phoneme to the first text; and
determining, based on the weight information, a weighted sum of the first target description feature and the second target description feature, as the third target description feature corresponding to the target phoneme.

11. The method of claim 10, wherein a weight corresponding to the first target description feature is inversely proportional to the distance.

12. The method of claim 1, wherein the input phoneme sequence further comprises an attribute description feature indicating a target speech attribute.

13. The method of claim 12, wherein the attribute description feature comprises:
a first attribute description feature determined based on a specified attribute identifier; or
a second attribute description feature generated by encoding an audio token sequence corresponding to the target speech attribute.

14. The method of claim 13, wherein the second attribute description feature is generated by encoding at least a part of the reference description feature and the audio token sequence.

15. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a reference description feature corresponding to prompted speech content, the reference description feature comprising a text encoding representation determined by processing the prompted speech content with a contrastive learning module, and the text encoding representation describing a first expression state of the prompted speech content;
constructing, based on the reference description feature, a target description feature for indicating a target expression state; and
generating target speech content corresponding to the target expression state based on an input phoneme sequence comprising the target description feature.

16. The electronic device of claim 15, wherein the acts further comprise training the contrastive learning module through:
generating a training acoustics feature based on a speech token sequence of a speech sample;
generating a description text for describing an expression state of the speech sample; and
training the contrastive learning module based on the training acoustics feature and a training text feature of the description text.

17. The electronic device of claim 15, wherein the reference description feature further comprises a state encoding representation of a second expression state, and the second expression state is the first expression state or a preset expression state.

18. The electronic device of claim 15, wherein constructing, based on the reference description feature, the target description feature for indicating the target expression state comprises:
constructing the target description feature by fusing the reference description feature and a preset control feature, the preset control feature being an expression state independent feature determined by a training process.

19. The electronic device of claim 15, wherein the target expression state is a first target expression state, the target speech content is first target speech content, the target description feature is a first target description feature, the first target speech content corresponds to a first text, and the method further comprises:
determining a second target description feature associated with a second text;
updating, based on the first target description feature, the second target description feature corresponding to a first segment of the second text, to determine a third target description feature, the first segment being adjacent to the first text;
generating, based on the third target description feature, second target speech content corresponding to the first segment; and
generating, based on the second target description feature, third target speech content corresponding to a second segment of the second text.

20. A non-transitory computer-readable storage medium having a computer program stored thereon, the computer program executable by a processor to perform acts comprising:
obtaining a reference description feature corresponding to prompted speech content, the reference description feature comprising a text encoding representation determined by processing the prompted speech content with a contrastive learning module, and the text encoding representation describing a first expression state of the prompted speech content;
constructing, based on the reference description feature, a target description feature for indicating a target expression state; and
generating target speech content corresponding to the target expression state based on an input phoneme sequence comprising the target description feature.
